(19) United States
(12) Patent Application Publication
(10) Pub. No.: US 2007/0054768 A1
(43) Pub. Date: Mar. 8, 2007

(54) Sintered sprocket with protrusions

(75) Inventor: Toshihiko Miyazawa, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/490,332

(22) Filed: Jul. 20, 2006

(30) Foreign Application Priority Data
Sep. 7, 2005 (JP) 2005-259249

(51) Int. Cl. F16H 55/30

(52) U.S. Cl. 474/152

(57) ABSTRACT

A sintered sprocket is formed with protrusions on both sides, arranged along a tooth gap bottom circle and centered on every second tooth. These protrusions engage the outer plates of a roller chain and maintain the chain in centered relationship with the sprocket.

### FIELD OF THE INVENTION

This invention relates to a sprocket for driving or driven engagement with a chain in a chain transmission. The chain can be, for example, a roller chain, a bushing chain, or a bushingless chain (that is, a chain in which outer plates are connected by pins, either with or without rollers, but without bushings). More specifically, the invention relates to a sintered sprocket having protrusions formed on its sides for guiding the chain into symmetrical relationship with the sprocket as it comes into engagement with the sprocket.

### BACKGROUND OF THE INVENTION

A chain such as a roller chain, a bushing chain or a bushingless chain can be used for power transmission in various industrial machines and in other applications, such as in the timing drive system of an automobile engine. The chain comprises pairs of inner plates in spaced, side-by-side relationship, and pairs of outer plates, also in spaced-side by side relationship. The pairs of inner plates are interleaved with the pairs of outer plates in alternating relationship to form an endless chain. The outer plates of each pair are connected by two pins, and each pin extends through a pair of inner plates, so that adjacent pairs of inner and outer plates are articulably connected to each other. In the case of a bushing chain, each of the pins which connects a pair of outer plates extends through a bushing fitted to a pair of inner plates. In the case of a roller chain, a roller is rotatable on a bushing, or on a pin if a bushing is not present.

In a chain transmission, the chain is typically engaged with a driving sprocket and one or more driven sprockets. When the chain begins to engage with a sprocket, it sometimes approaches the sprocket with a slight sideways shift. When the sideways shift occurs, the inner plates engage and move along curved inclined surfaces on the sides of the sprocket tooth heads and are thereby guided so that the rollers, bushings or pins can properly engage tooth gap bottoms of the sprocket.

When the chain approaches the sprocket with a sideways shift, a phenomenon known as one-sided contact occurs. That is, only one inner plate of each pair of inner plates comes into contact with the sprocket teeth. One proposal to prevent one-sided contact is described in Japanese Laid-Open Patent Publication No. 2000-329218. There, to prevent one-sided contact between an exhaust cam sprocket and a timing chain in a dual overhead cam (DOHC) internal combustion engine, the tooth width of the exhaust cam sprocket is made smaller than the tooth width of the intake cam sprocket. Even if the sprockets are shifted axially with respect to each other, so long as the narrower exhaust cam sprocket teeth provide a sufficient clearance, one-sided contact between the chain and the exhaust cam sprocket teeth can be prevented.

When the misalignment of two sprockets is too large, and the lateral movement of the chain is too large, the lateral shift of the chain cannot be accommodated by a clearance produced by making the teeth of one sprocket smaller than the teeth of another sprocket. The inner plates of the chain and outer sides of the sprocket contact each other, generating friction loss, and, as illustrated in FIG. 7, causing wear at an area Q of frictional contact between an inner plate and a sprocket tooth 4.

This invention addresses the above-mentioned problems and provides a sprocket in which, as a chain begins engage with a sprocket, even if misalignment results in a lateral shift of the chain, contact between inner plates of the chain and outer sides of the sprocket can be prevented, and friction loss and sprocket wear can be prevented.

### SUMMARY OF THE INVENTION

Briefly, in accordance with the invention, a sintered sprocket is formed with protrusions on both of its sides, the protrusions being arranged along a tooth gap bottom circle and centered on every second tooth. These protrusions engage the outer plates of a roller chain, and maintain the chain in centered relationship with the sprocket.

The sintered sprocket according to the invention is rotatable about an axis of rotation and has opposite, axially facing, sides, and a periphery with sprocket teeth formed thereon. The sprocket teeth have tooth heads, and adjacent sprocket teeth are spaced from one another by tooth gaps with tooth gap bottoms tangent to a circle centered on the sprocket's axis of rotation. Protrusions are formed on both sides of the sprocket at intersections of the circle with radial lines extending from the axis to centers of heads of the sprocket teeth. The protrusions are preferably provided at intersections of the circle with radial lines extending from said axis to the center of every second tooth on the periphery of the sprocket.

When the sprocket is used in a transmission, it is engaged with a transmission chain comprising pairs of inner plates in spaced, side-by-side relationship and pairs of outer plates also in spaced-side by side relationship, the pairs of inner plates being interleaved with the pairs of outer plates in alternating relationship. The outer plates of each pair are connected by two pins, and each pin extends through a pair of inner plates, whereby adjacent pairs of inner and outer plates are articulably connected to each other. The chain is engaged with the sprocket teeth, and the protrusions extend axially past the inner plates and are engageable with the outer plates.

If the chain is shifted laterally to one side as it approaches the sprocket, the outer plate slides onto a protrusion which effects a correcting action, bringing the chain into a symmetrical relationship with the sprocket, so that contact between the inner plates of the chain and the sides of the sprocket is prevented. As a result, friction loss, and wear of the side of the sprocket and of the inner plates of the chain are prevented. Furthermore, since the position of the chain is corrected, that is, the center of the chain is brought to a central position midway between the sides of the sprocket, inflow of lubricating oil between the pins and bushings, and between the bushings and rollers, is facilitated, and lubrication is improved so that the wear elongation of the chain can be reduced.

### BRIEF DESCRIPTION OF THE DRAWINGS

FIG. 1 is a schematic side elevational view of portion of a sprocket according to a first embodiment of the invention, showing the engagement between the sprocket and a roller chain;

FIG. 2 is a cross-sectional view taken on section plane X2-X2 in FIG. 1;

FIG. 3 is a schematic side elevational view of portion of a sprocket according to a second embodiment of the invention, showing the engagement between the sprocket and a roller chain;

FIG. 4 is a cross-sectional view taken on section plane X4-X4 in FIG. 3;

FIG. 5 is a schematic side elevational view of portion of a sprocket according to a third embodiment of the invention, showing the engagement between the sprocket and a roller chain;

FIG. 6 is a cross-sectional view taken on section plane X6-X6 in FIG. 5; and

FIG. 7 is fragmentary view side elevational view of a conventional sprocket tooth, illustrating the wear that can take place as a result of one-sided contact.

### DETAILED DESCRIPTION OF THE PREFERRED EMBODIMENTS

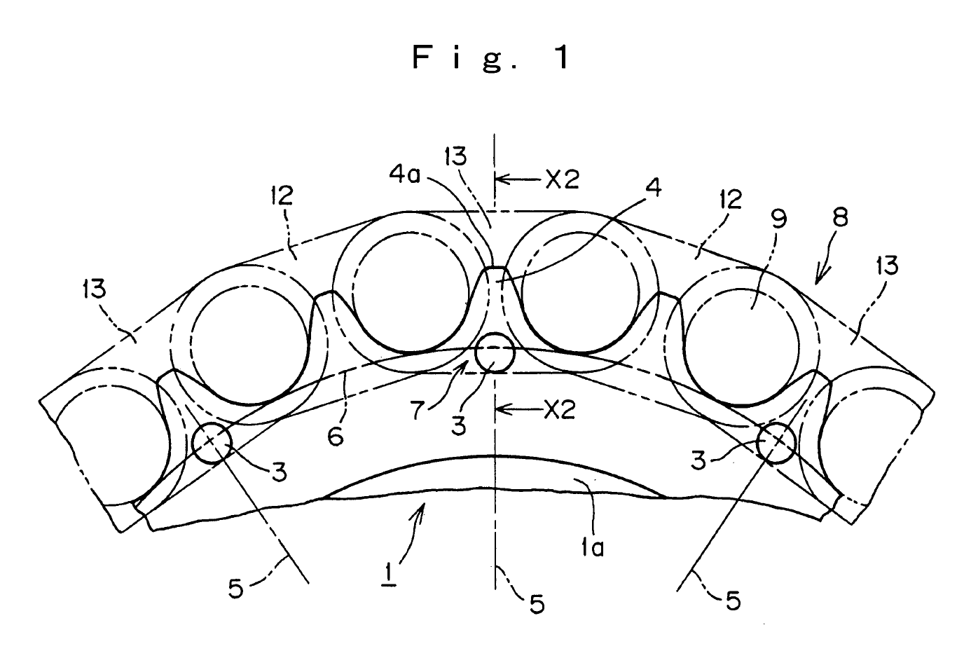

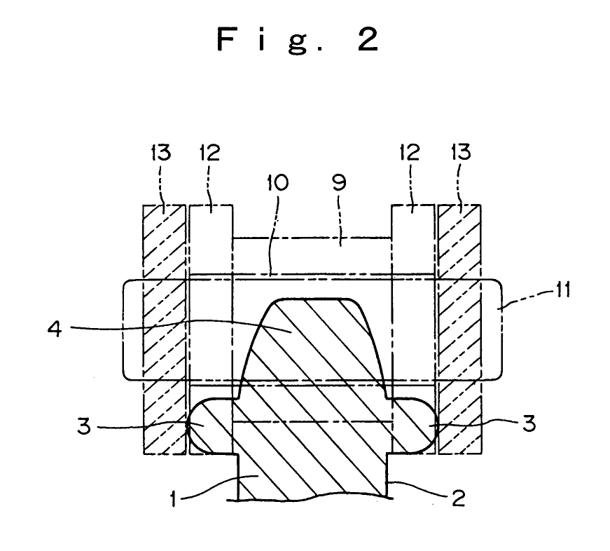

In the first embodiment of the invention, as shown in FIGS. 1 and 2, a sprocket 1 is provided with small protrusions 3 on both of its sides. As shown in FIG. 2, one projection 3 is provided on the right side 2 of the sprocket, and a similar projection 3 is provided on the opposite side. The projections are in the form of cylinders having rounded tips. The length of each protrusion 3 is slightly greater than the thickness of the inner plates 12 of a chain 8 engaged with the sprocket teeth, and the protrusions come into contact with inner faces of outer plates 13 of the chain 8.

The sprocket 1 is produced by sintering, and the protrusions are preferably unitary with the sprocket body, and composed of the same sintered material of which the hub 1a and the teeth 4 of the sprocket are composed. Alternatively, the protrusions can be separate elements fitted into holes in the sprocket, in which case, the protrusions can be made from any suitable material, and can be made so that they exhibit the same wear resistance as the wear resistance of the outer plates of the chain.

The protrusions 3 are located at the intersections 7 of straight radial lines 5 which connect the center (not shown) of the sprocket 1 with the centers 4a of the sprocket tooth heads, and an inscribed tooth gap bottom circle 6, to which the tooth gap bottoms are tangent. Preferably, the protrusions are centered, or nearly centered, on the intersections of the radial lines 5 and the tooth gap bottom circle 6. However, a protrusion can be considered to be located at an intersection of a radial line 5 and a tooth gap bottom circle if it is situated approximately at the location of the intersection, even if not exactly centered or nearly centered on the intersection. With the protrusions located along the tooth gap bottom line, they are positioned so that they can contact the outer plates of the chain as the chain comes into engagement with the sprocket.

The protrusions 3 are provided adjacent every second tooth on the sprocket so that they can protrude between successive inner plates 12 of the chain and come into contact with the outer plates 13 without coming into contact with the inner plates 12. Accordingly, the sprocket 1 must have an even number of teeth. The location of the protrusions along radial lines extending from the axis of rotation of the sprocket to the centers of the tooth heads ensures that the protrusions will not interfere with the inner plates of the chain.

The chain 8, shown in FIGS. 1 and 2 comprises a pair of inner plates 12 and a pair of outer plates 13, pins 11 fitted to the outer plates 13. The pins 11 extend through bushings 10, which are fitted to the inner plates 12. Rollers 9 are rotatable on the bushings 10.

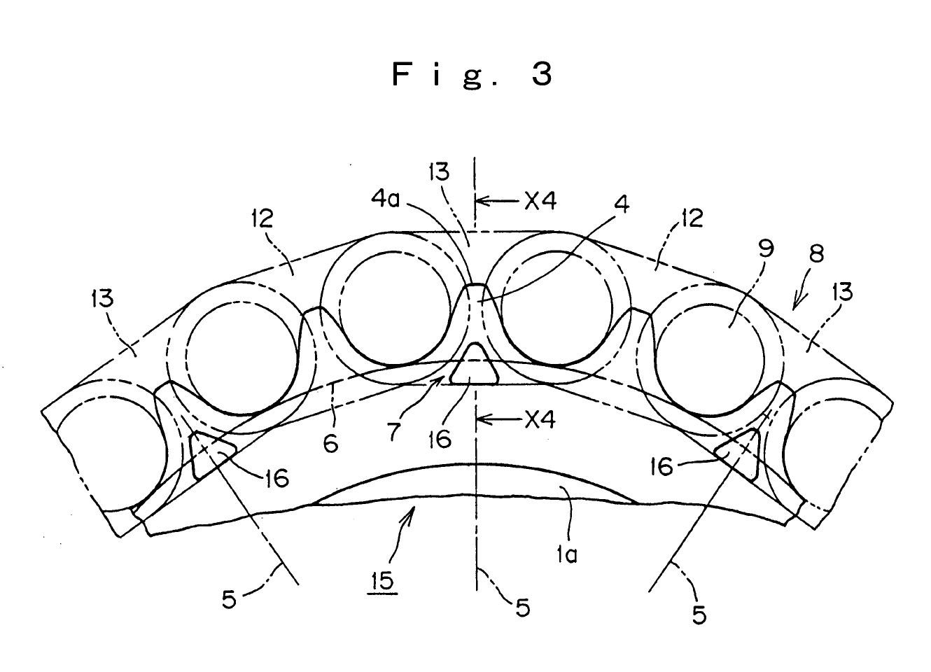

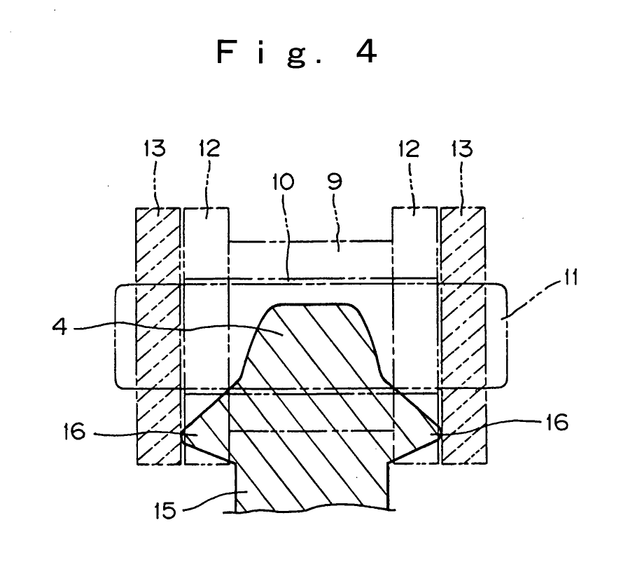

In the second embodiment of the invention, as shown in FIGS. 3 and 4, parts that are identical to corresponding parts in the embodiment of FIGS. 1 and 2 are designated by the same reference numbers. Sprocket 15 is provided with small protrusions 16, each of which is substantially in the form of a triangular pyramid having a rounded tip. The pyramid-shaped protrusions 16 are provided on both sides of the sprocket 15.

As in the first embodiment, the length of each pyramid-shaped protrusion 16 is slightly greater than the thickness of the inner plates 12 of the chain, and the protrusions come into contact with inner faces of the outer plates 13 of the chain. Here, as in the first embodiment, the sprocket is sintered, and the protrusions 16 are preferably unitary with the hub and teeth of the sprocket, and formed from the same sintered material as that of which the hub and teeth of the sprocket are composed. The protrusions 16 are located at the intersections 7 of straight radial lines 5 which connect the center of the sprocket 1 with the centers 4a of the sprocket tooth heads, and an inscribed tooth gap bottom circle 6, to which the tooth gap bottoms are tangent. The protrusions extend between the successive inner plates 12 of the chain and contact the outer plates 13.

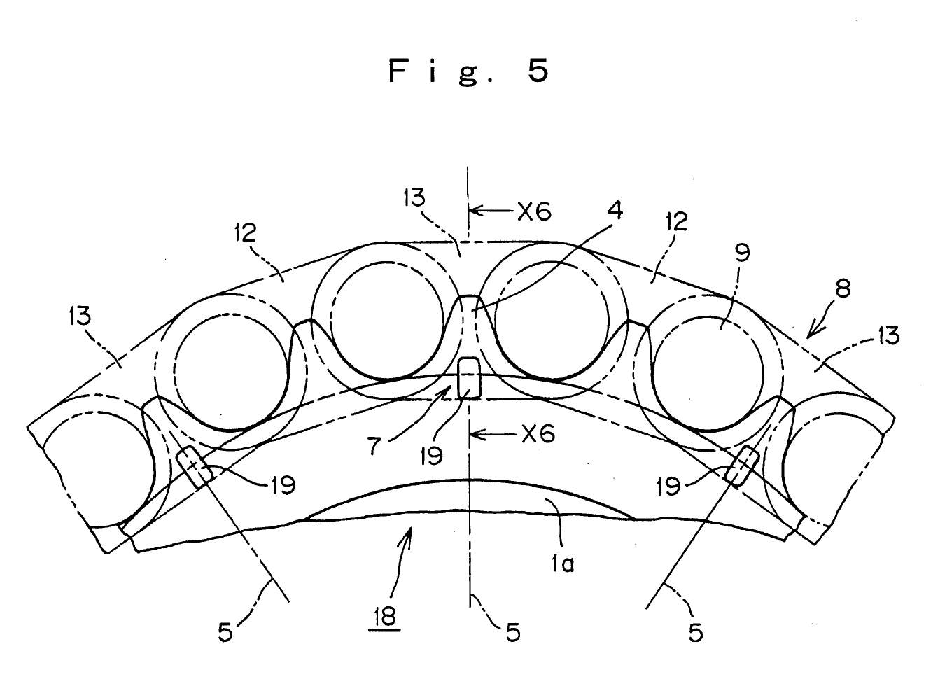

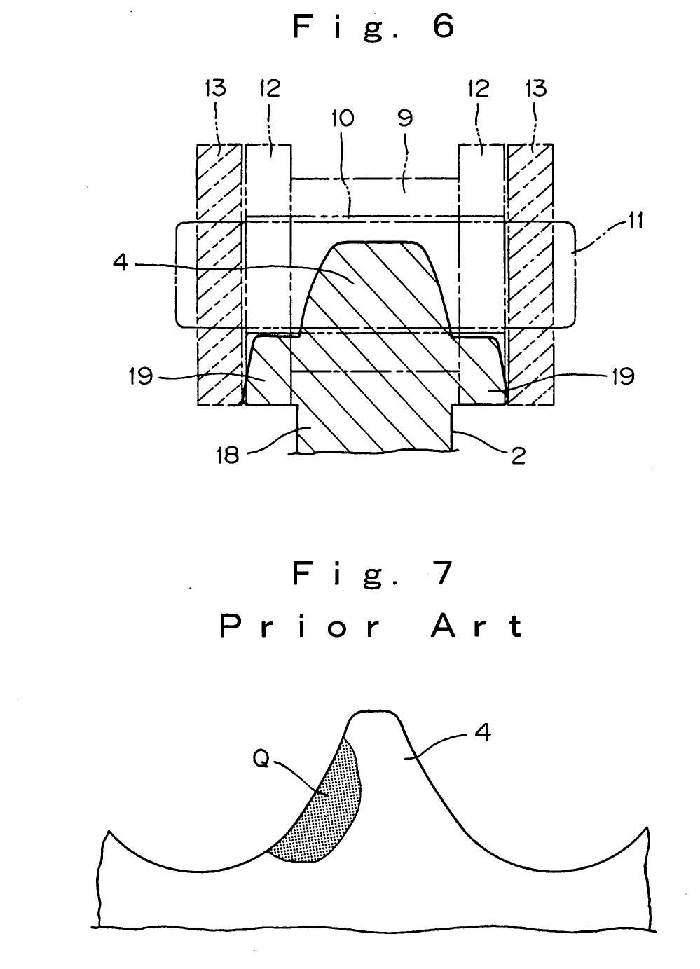

In the third embodiment of the invention, as shown in FIGS. 5 and 6, parts that are identical to corresponding parts in the embodiments of FIGS. 1-4 are designated by the same reference numbers. Sprocket 18 is provided with small protrusions 19, each of which is substantially rectangular in shape. The substantially rectangular-shaped protrusions 19 are provided on both sides of the sprocket 18.

As in the first and second embodiments, the length of each substantially rectangular-shaped protrusion 19 is slightly greater than the thickness of the inner plates 12 of the chain, and the protrusions come into contact with inner faces of the outer plates 13 of the chain. As in the first and second embodiments, the sprocket is sintered, and the protrusions 19 are preferably unitary with the hub and teeth of the sprocket, and formed from the same sintered material as that of which the hub and teeth of the sprocket are composed. The protrusions 19 are located at the intersections 7 of straight radial lines 5 which connect the center of the sprocket 1 with the centers of the sprocket tooth heads, and an inscribed tooth gap bottom circle, to which the tooth gap bottoms are tangent. The protrusions extend between the successive inner plates 12 of the chain and contact the outer plates 13. As shown in FIG. 6, the outer ends of the protrusions preferably have a slight convex curvature, and the parts of the protrusions that are nearer the axis of rotation of the sprocket are axially longer than the parts of the protrusions that are farther from the axis of rotation of the sprocket

In each of the sprockets 1, 15 and 18 described above, if the chain 8 approaches or engages with the sprocket 1 with a slight sideways shift, the outer plates of the chain are guided as they slide on the protrusions so that the position of the chain 8 is corrected, and the chain is brought into a symmetrical relationship with the sprocket as depicted in FIGS. 2, 4 and 6. Since the chain 8 is brought to a central position, contact between the inner plates 12 and sides 2 of the sprocket 18 is prevented. As a result, friction loss and wear of the sides 2 of the sprocket 18 and of the inner plates 12 are prevented. Furthermore, since the chain 8 is corrected to the central position, flow of lubricating oil into the clearance between the pin 11 and the bushing 10, and between the bushing 10 and the roller 9, is facilitated, lubrication is improved, and wear elongation of the chain is reduced.

Although the protrusions in the examples are respectively in the shape of cylinders with rounded tips, triangular pyramids, or substantially rectangular prisms, any of various other shapes can be adopted, such as a pyramid shape having four triangular faces and a rectangular base. Furthermore, although the invention has been described with reference to a roller chain having bushings, advantages of the invention can be realized in chain and sprocket transmissions utilizing bushing chains, i.e., chains having no rollers, and bushingless chains with our without rollers.

I claim:

1. A sintered sprocket rotatable about an axis of rotation and having opposite, axially facing, sides, and a periphery with sprocket teeth formed thereon, the sprocket teeth having tooth heads and adjacent sprocket teeth being spaced from one another by tooth gaps, and the tooth gaps having tooth gap bottoms tangent to a circle centered on said axis, the sprocket having protrusions formed on both of its sides, the protrusions being located at intersections of the circle with radial lines extending from said axis to centers of heads of the teeth.

2. A sintered sprocket according to claim 1, in which the protrusions are located at intersections of the circle with radial lines extending from said axis to the center of every second tooth on the periphery of the sprocket.

3. A chain and sprocket transmission comprising:
a sintered sprocket rotatable about an axis of rotation and having opposite, axially facing, sides, and a periphery with sprocket teeth formed thereon, the sprocket teeth having tooth heads and adjacent sprocket teeth being spaced from one another by tooth gaps, and the tooth gaps having tooth gap bottoms tangent to a circle centered on said axis, the sprocket having protrusions formed on both of its sides, the protrusions being located at intersections of the circle with radial lines extending from said axis to the center of every second tooth on the periphery of the sprocket; and
a chain engaged with the sintered sprocket, the chain comprising pairs of inner plates in spaced, side-by-side relationship and pairs of outer plates also in spaced-side by side relationship, the pairs of inner plates being interleaved with the pairs of outer plates in alternating relationship, the outer plates of each pair being connected by two pins, and each said pin extending through a pair of inner plates whereby adjacent pairs of inner and outer plates are articulably connected to each other;
the chain being engaged with the sprocket teeth, and the protrusions extending axially past the inner plates and being engageable with the outer plates.
